(19) United States
(12) Patent Application Publication
(10) Pub. No.: US 2014/0258170 A1
(43) Pub. Date: Sep. 11, 2014

(54) SYSTEM FOR GRAPHICALLY DISPLAYING USER-PROVIDED INFORMATION

(71) Applicant: Christopher Thomas Biscoe, Boulder, CO (US)

(72) Inventor: Christopher Thomas Biscoe, Boulder, CO (US)

(73) Assignee: SQUERB, INC., Boulder, CO (US)

(21) Appl. No.: 14/202,693

(22) Filed: Mar. 10, 2014

Related U.S. Application Data
(60) Provisional application No. 61/775,607, filed on Mar. 10, 2013.

(51) Int. Cl. G06Q 30/02

(52) U.S. Cl. CPC G06Q 30/0282
USPC 705/347

(57) ABSTRACT

Appraisal information associated with one or more topics are collected and provided via a graphically displayed interface. The interface is configured to graphically display descriptive appraisal information (language-based descriptors) and quantitative appraisal information (number-based descriptors) associated with a topic in a two-dimensional field as a semi-ordered perceptual map of choices. Such a choice map represents qualitative assessments of a particular topic in a way that facilitates immediate understanding of the feedback from a large number of end-users.

### CROSS REFERENCE

This non-provisional U.S. patent application claims the benefit of U.S. Provisional Patent Application No. 61/775,607, filed on Mar. 10, 2013, by inventor Christopher Thomas Biscoe, entitled “Squerb”.

### BACKGROUND OF THE INVENTION

1. Field of the Invention

Embodiments of the present invention relate generally to rating systems employing user-provided information and, more specifically, to a system for graphically displaying user-provided information.

2. Description of the Related Art

The ubiquity of Internet access has made user-generated reviews of products, services, events, and all forms of entertainment media an important resource to the modern consumer. Since the opinions of fellow consumers can provide invaluable information about a product or service that is otherwise difficult to obtain, consulting user reviews prior to a purchase has become standard practice for perspective consumers. Consequently, user-generated reviews are widely available on countless websites, including manufacturer and retailer websites, third-party review websites, and throughout social media.

However, while a large number of user reviews and other user-generated information can be readily accessed by consumers, the information included therein generally lacks any useful detail or is presented in a format that is too cumbersome to readily interpret. For example, the binary choice provided by the widely used like/don't like feature included in many websites imparts essentially no useful information or meaningful evaluation of a particular topic (such as a consumer product, a service, a movie, etc.), no matter how many users have provided input. Furthermore, this approach commonly does little more than raise more questions: To what degree is the topic liked or disliked? For what reasons is the topic liked or disliked? Are all aspects of the topic like or disliked equally? etc. Similarly, numerical rating scales, in which a topic is rated on a scale of one-to-three, one-to-five, etc., also fail to gather and present meaningful information, raising the same questions (except for degree of like/dislike) as a like/dislike rating system.

To address this concern, some websites also include reviewer comments, thereby allowing a reviewer to provide more qualitative information than a simple rating value. Such qualitative assessments include much more helpful information for those interested in a particular topic than a simple numerical or like/dislike rating. Unfortunately, the helpful information to be found in reviewer comments is largely inaccessible, being buried in the cumbersome format of unorganized prose, with no means for selecting information of interest from an endless scroll of reviewer comments. In addition, there is no way for such information from multiple reviewers to be quantified or otherwise categorized. So although a reviewer may commit significant effort in communicating his or her experience or opinion related to a particular topic, the likelihood this information will be helpful to other users is low.

Accordingly, there is a need in the art for a more effective approach for gathering and presenting user reviews and other feedback.

### SUMMARY OF THE INVENTION

One embodiment of the present invention sets forth a computer-implemented method for collecting and providing appraisal information associated with one or more topics by employing a graphically displayed interface. The method comprises receiving a request for appraisal information associated with a topic via an information network, and causing descriptive appraisal information associated with the topic and quantitative appraisal information associated with the topic to be graphically displayed in conjunction with a two-dimensional field that includes a first axis and a second axis, wherein the first axis represents an appraisal scale of the topic with respect to a first metric and the second axis represents an appraisal scale of the topic with respect to a second metric.

One advantage of the above-described embodiment is the ability to collect qualitative assessments of a topic with the efficiency and simplicity of a conventional numerical rating system. Another advantage is that such qualitative assessments, once collected, can be readily accessed and searched, and the results of such a search can be quickly interpreted. A further advantage is that data aggregation in terms of specific language-based descriptors provides an additional layer of subjective, but easily understood feedback.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic diagram of a computer-implemented counting tool, according to an embodiment of the present invention.

FIG. 2 is a schematic diagram of a two-dimensional field when the counting tool of FIG. 1 is employed for displaying previously collected appraisal information associated with a particular topic, according to an embodiment of the present invention.

FIG. 3 is a schematic diagram of a quadrant of the two-dimensional field of FIG. 2 configured as part of a geometry-based hierarchy, according to one embodiment of the invention.

FIG. 4 is a schematic diagram of a quadrant of the two-dimensional field of FIG. 2 in which a language-based descriptor is associated with a subset of additional language-based descriptors, according to one embodiment of the invention.

FIG. 5 is a conceptual block diagram illustrating a computer-implemented system configured for collecting and providing information, according to one embodiment of the present invention.

FIG. 6 is a conceptual block diagram illustrating a computer-implemented system configured for collecting and providing information, according to another embodiment of the present invention.

FIG. 7 is a conceptual block diagram illustrating a computer-implemented system configured for collecting and providing information, according to another embodiment of the present invention.

FIG. 8 sets forth a flowchart of computer-implemented method steps for providing information, according to one embodiment of the present invention.

FIG. 9 sets forth a flowchart of computer-implemented method steps for searching for appraisal information associated with a topic, according to one embodiment of the present invention.

FIG. 10 sets forth a flowchart of computer-implemented method steps for retrieving information from a database, according to one embodiment of the present invention.

For clarity, identical reference numbers have been used, where applicable, to designate identical elements that are common between figures. It is contemplated that features of one embodiment may be incorporated in other embodiments without further recitation.

### DETAILED DESCRIPTION

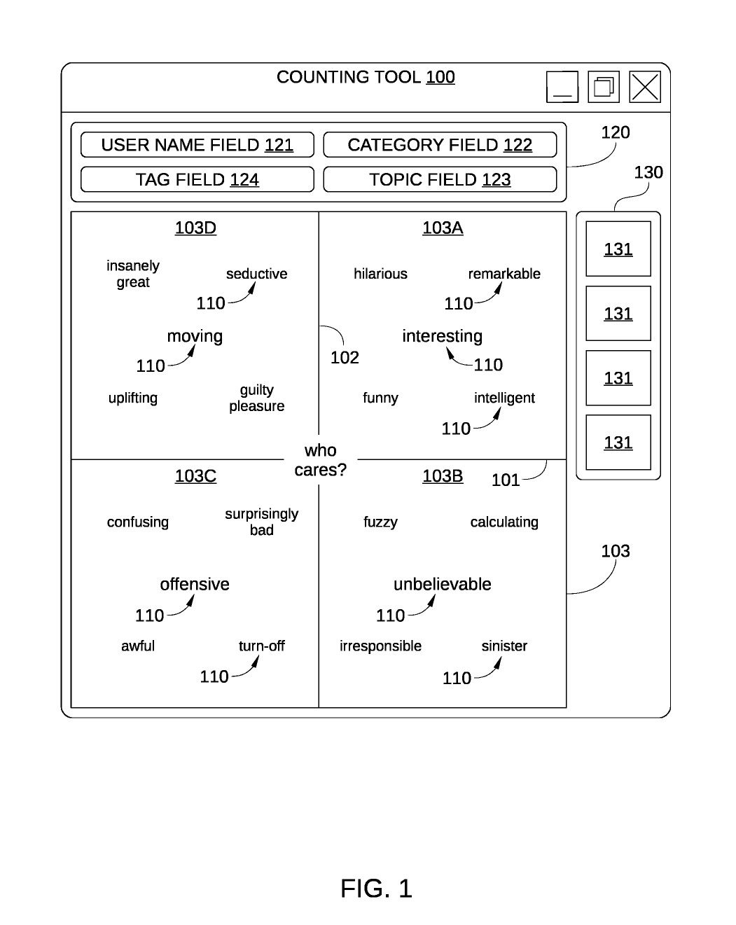

According to embodiments of the invention, a computer-implemented counting tool is configured to graphically collect and display user-provided information about any subject or topic. The counting tool includes a Cartesian plane, on which feedback words and phrases, chosen for contextual applicability to a particular topic of interest, are arrayed thereon. Furthermore, the feedback words or phrases are arranged with respect to a first axis, representing an appraisal scale of the topic with respect to a first metric, and a second axis, representing an appraisal scale of the topic with respect to a second metric. One embodiment of the counting tool is illustrated in FIG. 1.

FIG. 1 is a schematic diagram of a computer-implemented counting tool 100, according to an embodiment of the present invention. Counting tool 100 may be a graphically displayed interface, such as a graphical user interface (GUI), configured for collecting and/or displaying a “topic appraisal,” for example, user appraisal input regarding a particular topic of interest, such as a book, movie, or video, a consumer product or server, a restaurant, or any topic suitable for review by users or consumers. Counting tool 100 may be configured for display using any technically feasible display approach on any suitable computing device, including a browser on an electronic tablet, a browser or application on a desktop system, and/or a tablet/mobile phone-based native application, among others. The user appraisal information displayed in conjunction with counting tool 100 may be a topic appraisal that is currently being generated by an end-user, or may be an existing topic appraisal requested by an end-user. It is noted that a requested topic appraisal may include appraisal information generated by a plurality of users, by a specific desired user, or by a specific subset of users, such as a group of individuals linked via social media.

Counting tool 100 includes a first axis 101, a second axis 102, and a two-dimensional field 103, arranged as shown. Counting tool 100 also includes a plurality of language-based descriptors 110, each of which is displayed at a different location in two-dimensional field 103. In some embodiments, counting tool 100 may include a metadata field 120 and an aspect selection field 130.

Metadata field 120 is configured for entering and/or displaying metadata associated with the topic appraisal currently displayed by counting tool 100. Metadata field 120 may include a user name field 121, a category field 122, a topic field 123, and/or a tag field 124, among others. User name field 121 is configured to display a user name associated with the topic appraisal currently displayed by counting tool 100, and may indicate an individual end-user or a group of end-users. When counting tool 100 is used to collect appraisal information regarding a topic, user field name 121 displays the user name of the end-user currently generating a topic appraisal of the topic. Category field 122 is configured to display the category or categories (such as books, restaurants, songs, news articles, etc.) to which the topic of interest belongs. Alternatively, when counting tool 100 is used to collect appraisal information regarding a particular topic, category field 122 may be used as a search filter. Similarly, topic field 123 is configured to display the current topic (such as a particular book, restaurant, song, news article, etc.) for which appraisal information is displayed using counting tool 100, and may be used as a search filter when counting tool 100 is used to collect appraisal information regarding the topic of interest. Tag field 124 is configured to display which of language-based descriptors 110 have been associated with the topic indicated in topic field 123 by the user indicated in user field name 121. And, similar to category field 122 and topic field 123, tag field 124 may also be configured as a search filter.

In some embodiments, counting tool 100 may include aspect selection field 130. Aspect selection field 130 is configured with buttons 131 that allow an end-user to select a specific aspect of the topic of interest. For example, when a topic is a movie, buttons 131 may indicate various aspects associated with movies, such as acting, cinematography, directing, music, plot, and the like. In another example, when a topic is a restaurant, buttons 131 may indicate various aspects associated with a restaurant, such as service, food, value, and the like. When an end-user selects a particular aspect via buttons 131, counting tool 100 then only displays previously collected appraisal information (e.g., language-based descriptors 110 selected by end-users) associated with that aspect. In this way, counting tool 100 greatly facilitates searching through appraisal information associated with a particular topic, since an end-user can avoid reading and otherwise sorting through appraisal information that is not related to an aspects of the topic that the end-user is interested in. When counting tool 100 is employed to collect appraisal information regarding a topic, each of buttons 131 enables an end-user to provide appraisal information for a particular aspect of the topic of interest. In this way, counting tool 100 also facilitates the collection of appraisal information for one or more specific aspects of a topic.

As shown, first axis 101 and second axis 102 may be configured to divide two-dimensional field 103 into quadrants that may be uniform in size or may vary in size. In addition, first axis 101 represents an appraisal scale of a particular topic with respect to a first metric, and second axis 102 represents an appraisal scale of said topic with respect to a second metric. For example, in the embodiment illustrated in FIG. 1, the first metric may be intellectual intensity associated with the topic of interest and the second metric may be emotional intensity associated with the topic. Language-based descriptors 110 are then arranged in two-dimensional field 103 accordingly, for example, positioned with respect to increasing or decreasing values of the first and second metric. Thus, two-dimensional field 103 may be configured as a semi-ordered perceptual map of choices, in the form of language-based descriptors 110 (e.g., words or phrases), that reflects qualitative feedback from one or a plurality of end-users.

Language-based descriptors 110 are feedback words or phrases that can be selected by one or more reviewers, consumers, or other individuals evaluating a particular topic. For a particular topic, each of language-based descriptors 110 is generally positioned in the same unique location in two-dimensional field 103 by counting tool 100. Taken together, a particular configuration of language-based descriptors 110 and locations in two-dimensional field 103 for a particular topic make up a “language set.” For example, in the embodiment illustrated in FIG. 1, the language set for a particular topic includes the following language-based descriptors 110 and positions: in quadrant 103A of two-dimensional field 103, “interesting,” “hilarious,” “remarkable,” “funny,” and “intelligent”; in quadrant 103B, “unbelievable,” “fuzzy,” “calculating,” “irresponsible,” and “sinister”; in quadrant 103C, “offensive,” “confusing,” “surprisingly bad,” “awful,” and “turn-off”; and in quadrant 103D, “moving,” “insanely great,” “seductive,” “uplifting,” and “guilty pleasure.” Consequently, for a given topic or category of topics, a uniform presentation of the words or phrases and corresponding locations in two-dimensional field 103 for language-based descriptors 110 (e.g., a fixed language set) may be established. In this way, quick and accurate understanding of user feedback is facilitated by the graphical presentation of qualitative, language-based information associated with a topic of interest. In other words, user feedback for a topic from a large number of sources can be interpreted at a glance, through immediate visualization.

In the embodiment illustrated in FIG. 1, the language set displayed by counting tool 100 provides a total of 21 unique language-based descriptors 110 for a particular topic, but in other embodiments more or fewer language-based descriptors 110 may make up a language set. Regardless of the number of language-based descriptors 110 included in a language set, each language-based descriptor 110 of the language set is positioned in the same unique location in two-dimensional field 103 by counting tool 100. This consistent positioning of language-based descriptors 110 is employed when counting tool 100 is used to collect appraisal information for a topic and also when an end-user employs counting tool 100 for searching and reviewing previously collected topic appraisals.

In some embodiments, a language set may include different language-based descriptors 110 than those listed above. For example, in some embodiments, the language-based descriptors 110 of a language set may be context-specific, and therefore may vary depending on what topic or aspect of a topic is currently displayed by counting tool 100. For example, counting tool 100 may employ a different language set when an end-user is evaluating a movie than when an end-user is evaluating a restaurant. In another example, counting tool 100 may employ a different language set based on which particular end-user is searching for a topic appraisal and/or generating a topic appraisal. For example, in one such embodiment, a language set employed by counting tool 100 may be selected based on what demographic or psychographic profile is associated with the end-user.

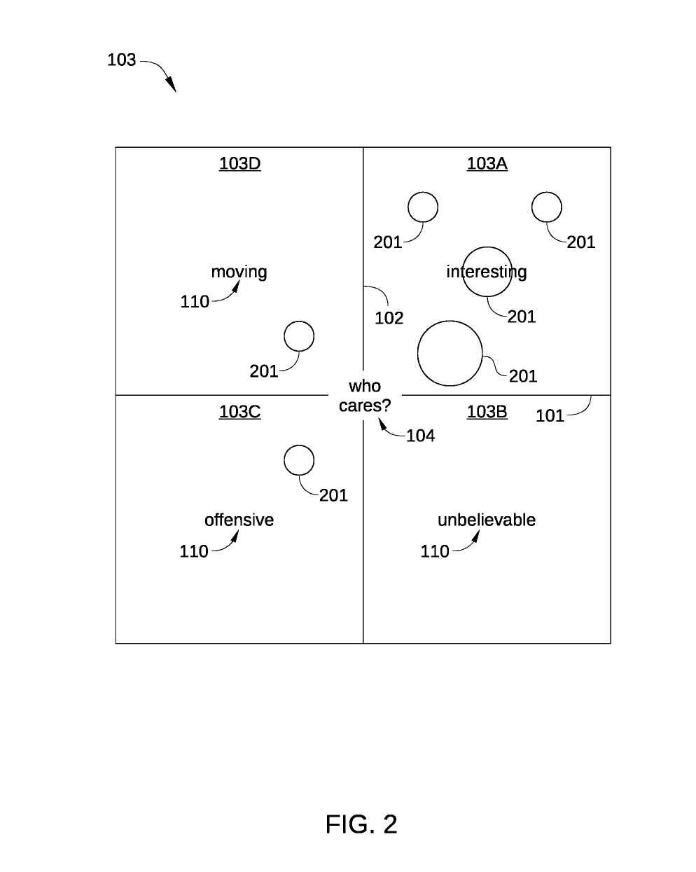

When a first end-user evaluates a particular topic (e.g., when counting tool 100 is used to collect appraisal information), the end-user selects one of language-based descriptors 110 to describe the topic, and counting tool 100 saves this input. Counting tool 100 can then be used to graphically display the selected language-based descriptor 110 when any end-user subsequently views the first end-user's topic appraisal. Furthermore, when multiple topic appraisals have been completed and aggregated for a particular topic, (e.g., multiple end-users have selected language-based descriptors 110), counting tool 100 can graphically display each of these appraisals simultaneously in two-dimensional field 103. One such embodiment is illustrated in FIG. 2.

FIG. 2 is a schematic diagram of two-dimensional field 103 when counting tool 100 is employed for displaying previously collected appraisal information associated with a particular topic, according to an embodiment of the present invention. In FIG. 2, two-dimensional field 103 is populated with appraisal information from a plurality of users. As shown, counting tool 100 may cause one or more value icons 201 to be displayed in two-dimensional field 103. Value icons 201 are depicted as circles in FIG. 2, but in other embodiments, may be any geometric shape or pictogram suitable for use in a GUI. In some embodiments, each value icon 201 may be a unique icon corresponding to a particular end-user. Each of value icons 201 is positioned at a location corresponding to one of the unique language-based descriptors 110 provided by counting tool 100 for a particular topic. The presence of a value icon 201 indicates that one or more end-users have, for the topic of interest, selected the language-based descriptor 110 corresponding to that location. Thus, counting tool 100 enables an end-user to graphically map a community of individual opinions in a meaningful and easily interpreted way. It is noted that for clarity the majority of language-based descriptors 110 are omitted in FIG. 2.

In some embodiments, the value icon 201 displayed at each location has a characteristic that is used to graphically indicate the number of end-users that have selected the language-based descriptor 110 corresponding to that location. Specifically, a value of the characteristic is proportional or otherwise related to the number of end-users that have selected the corresponding language-based descriptor 110. In this way, quantitative appraisal information associated with a topic (e.g., the number of end-users that have selected a particular language-based descriptor 110 for the topic), can be graphically represented in two-dimensional field 103. Consequently, a deeper understanding of appraisal information from a plurality of sources or end-users can be quickly assessed. In contrast, gleaning such information from a plurality of reviews written in prose form is extremely time-consuming, and any information so obtained is difficult to use for comparison to other related topics.

Suitable characteristics that may be employed to graphically indicate the number of end-users in this way include height, width, area, and/or color of value icon 201, among others. For example, in the embodiment illustrated in FIG. 2, the area of each value icon 201 as displayed is related to the number of end-users associated with that value icon 201. Thus, as the number of end-users associated with a value icon 201 increases, the area of the value icon 201 also increases. In such embodiments, the increase in the value of the characteristic may be directly proportional to the number of end-users being graphically represented. In other embodiments, to accommodate larger numbers of end-users, the increase in the value of the characteristic may be significantly less than directly proportional to the number of end-users being graphically represented.

Alternatively or additionally, a color of each value icon 201 may vary as the number of end-users associated with a value icon 201 increases. For example, a different color may correspond to a different range of the number of end-users being represented (e.g., violet=1-10, blue=11-50, green=51-100, etc.). Alternatively or additionally, the number of end-users that have selected the language-based descriptor 110 corresponding to that location may be displayed in numerical form inside and/or proximate to each of value icons 201.

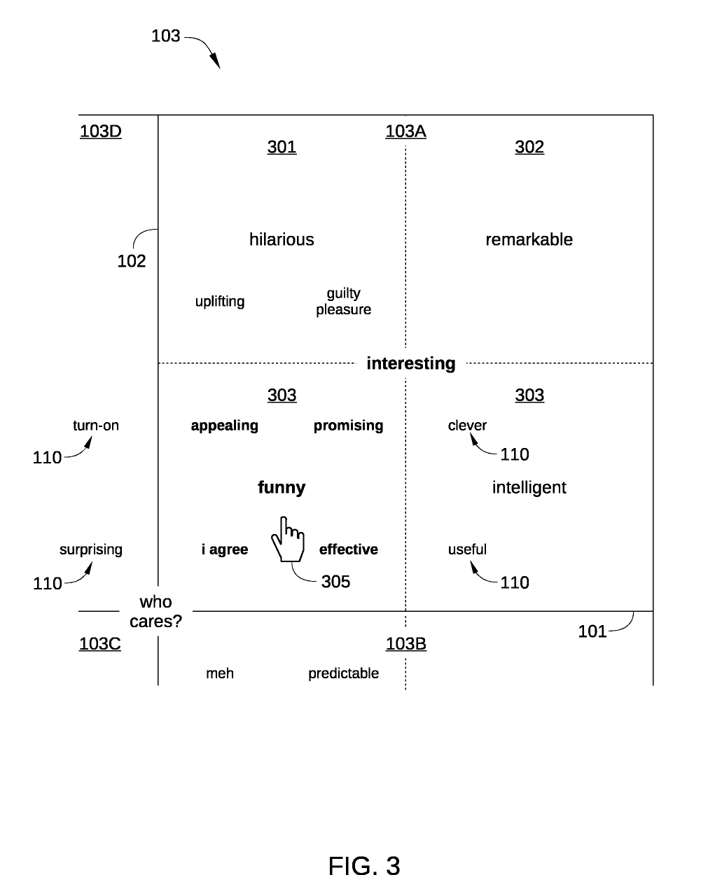

In some embodiments, language-based descriptors 110 may be arranged in a geometry-based hierarchy. Having language-based descriptors 110 arranged in such a hierarchy can facilitate the location of a suitable language-based descriptor 110 when counting tool 100 is employed to collect appraisal information from user input. Specifically, in such a geometry-based hierarchy, a small number (e.g., five) of higher-level language-based descriptors 110 are first displayed to an end-user who is providing appraisal information related to a particular topic. For example, as shown in FIG. 1, “interesting” is displayed as a possible selection in quadrant 103A, “unbelievable” is displayed as a possible selection in quadrant 103B, “offensive” is displayed as a possible selection in quadrant 103C, “moving” is displayed as a possible selection in quadrant 103D, and “who cares” is displayed as a possible selection at a centerpoint 104 of two-dimensional field 103 (e.g., the intersection of first axis 101 and second axis 102). Then, as the end-user navigates to one of quadrants 103A-103D, for example by moving a cursor, pointer, or other position indicator, counting tool 100 displays additional language-based descriptors 110 for that quadrant. FIG. 3 illustrates one such embodiment.

FIG. 3 is a schematic diagram of quadrant 103A of two-dimensional field 103 configured as part of a geometry-based hierarchy, according to one embodiment of the invention. As shown, when a cursor 305 is positioned in quadrant 103A, additional language-based descriptors 110 are displayed in quadrant 103A. For clarity, in some embodiments only language-based descriptors 110 proximate cursor 305 are displayed by counting tool 100, rather than all of language-based descriptors 110 in quadrant 103A. In some embodiments, language-based descriptors 110 are displayed more prominently (e.g., larger, bolder, brighter, or otherwise more visually prominent) when closer to cursor 305 and less prominently when farther from cursor 305.

In some embodiments, to facilitate speedy location by an end-user of a suitable language-based descriptor 110, language-based descriptors 110 may be arranged in a geometry-based hierarchy that includes higher-level descriptors, lower-level descriptors, and, in some embodiments, bottom-level descriptors. In such embodiments, each of the higher-level descriptors is associated with one of quadrants 103A-103D and the center point of two-dimensional field 103. For example, in the embodiment illustrated in FIG. 1, “interesting” is the higher-level descriptor associated with quadrant 103A, “unbelievable” is the higher-level descriptor associated with quadrant 103B, “offensive” is the higher-level descriptor associated with quadrant 103C, and “moving” is the higher-level descriptor associated with quadrant 103D. Furthermore, four lower-level descriptors, each corresponding to a language-based descriptor 110, is associated with each subquadrant of quadrants 103A-103D. For example, as shown in FIG. 3, the language-based descriptors 110 “hilarious,” “remarkable,” “intelligent,” and “funny” are associated with subquadrants 301-304, respectively, of quadrant 103A.

It is noted that these lower-level descriptors are generally arranged proximate the higher-level descriptor that is most closely related thereto. Similarly, in some embodiments, each of the language-based descriptors 110 “hilarious,” “remarkable,” “intelligent,” and “funny” may have additional language-based descriptors 110 (e.g., bottom-level descriptors) disposed nearby that are related in meaning. For example, as shown in FIG. 3, the lower-level descriptor “funny” located in subquadrant 303 may have the four bottom-level descriptors “appealing,” “promising,” “effective,” and “agreeable” disposed nearby. In addition, for consistency, each of these lower-level and bottom-level descriptors may also be positioned with respect to first axis 101 based on a subjective interpretation of the intellectual intensity of the descriptor and with respect to second axis 102 based on a subjective interpretation of the emotional intensity of the descriptor.

In the embodiment illustrated in FIG. 3, the geometry-based hierarchy of language-based descriptors 110 is configured with three levels of granularity: higher-level descriptors, lower-level descriptors, and bottom-level descriptors. In other embodiments, one or more additional levels of granularity of language-based descriptors 110 may be implemented. For example, each of bottom level indicators in FIG. 3 may also be associated with a smaller sub-quadrant or other sub-region of two-dimensional field 103 that is populated with four (or any other number) additional language-based descriptors 110. These additional language-based descriptors 110 may be selected based on having meanings considered closely related to the corresponding bottom-level indicator. Each of these additional language-based descriptors 110 may in turn be associated with a still smaller sub-quadrant or other sub-region, and so on. In such embodiments, highly technical feedback can be received from end-users through these additional levels of granularity.

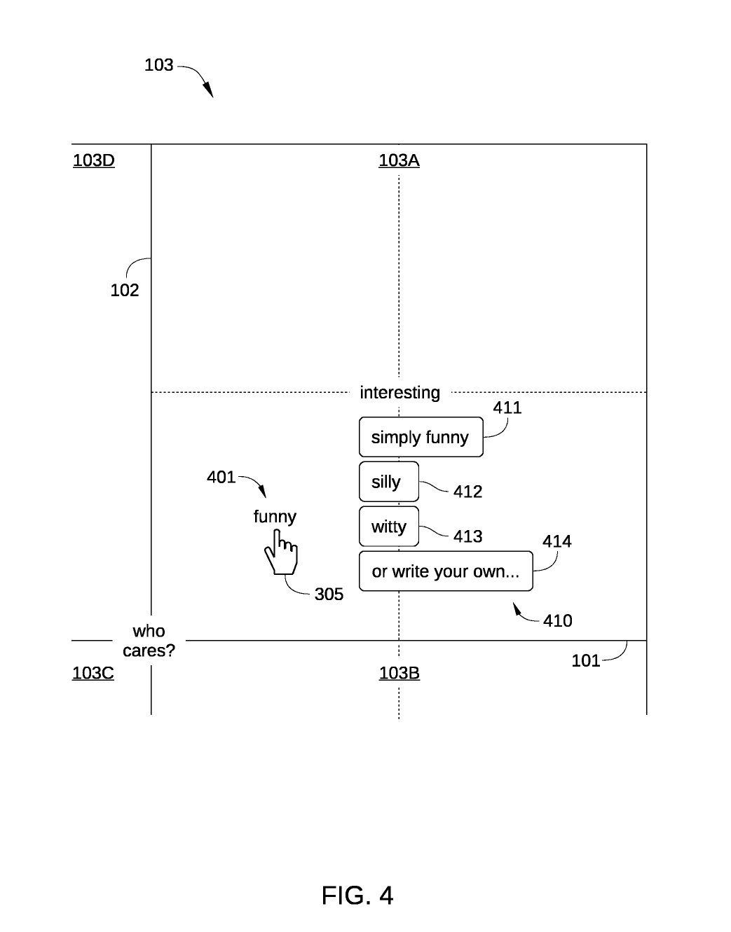

In some embodiments, one or more of the language-based descriptors 110 populating two-dimensional field 103 may be associated with a subset of additional language-based descriptors that provide a second level of descriptive appraisal information related to the topic. One such embodiment is illustrated in FIG. 4. FIG. 4 is a schematic diagram of quadrant 103A of two-dimensional field 103 in which a language-based descriptor 401 is associated with a subset 410 of additional language-based descriptors 411-414, according to one embodiment of the invention.

FIG. 4 depicts a portion of counting tool 103 after an end-user selects language-based descriptor 401 (in this case “funny”) to describe a particular topic. As shown, subset 410 may be configured as a drop-down menu of additional language-based descriptors 411-414, and may include unique language-based descriptors 411-414 that are displayed when an end-user selects language-based descriptor 401. Some or all of language-based descriptors 411-414 may be predetermined language-based descriptors. In some embodiments, some or all of language-based descriptors 411-414 may be language-based descriptors that are user-contributed descriptors originating from previous end-user input related to the topic. For example, one or more of the user-contributed descriptors may be written in by a different end-user than the end-user currently evaluating the topic. The second level of descriptive appraisal provided by language-based descriptors 411-414 can facilitate greater nuance for the topic than the language-based descriptors 110 included in the current language.

Furthermore, in some embodiments, one or more of language-based descriptors 411-414 may be associated with an additional subset of language-based descriptors (not shown for clarity). The elements of this additional subset of language-based descriptors may be selected based on having meanings considered closely related to the corresponding bottom-level indicator. Thus, when one of language-based descriptors 411-414 is selected, the additional subset may be displayed, for example as an additional drop-down menu, thereby providing an additional level of granularity in describing a topic. Each selection displayed in the additional subset may in turn have a subset of descriptors associated therewith, and so on, providing any number of additional levels of granularity in meaning. In such embodiments, highly technical feedback can be received from end-users through these additional levels of granularity.

In some embodiments, language-based descriptors 411-414 that are displayed to provide a second level of descriptive appraisal information may be selected based on popularity of usage by previous end-users. Alternatively or additionally, one or more of the user-contributed descriptors may be written in by the end-user end-user currently evaluating the topic. In the embodiment illustrated in FIG. 4, language-based descriptors 411-413 are predetermined language-based descriptors or language-based descriptors previously suggested by other end-users, while language-based descriptor 414 is configured as a write-in option for the end-user currently evaluating the topic.

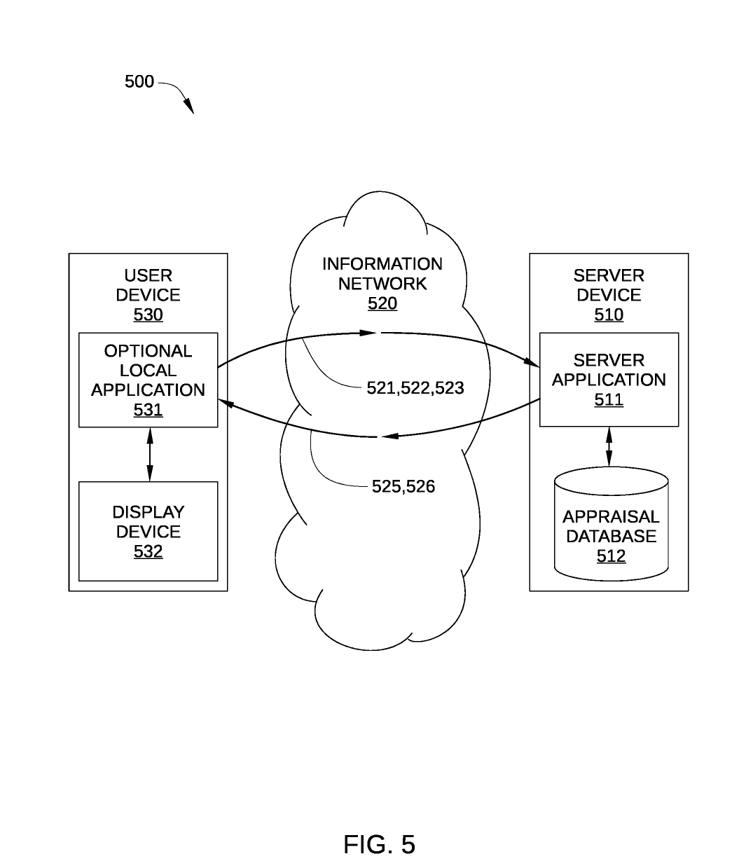

FIG. 5 is a conceptual block diagram illustrating a computer-implemented system 500 configured for collecting and providing information, according to one embodiment of the present invention. Computer-implemented system 500 includes a server device 510 and a user device 530. In the embodiment illustrated in FIG. 5, data are transmitted between server device 510 and user device 530 via an information network 520. Any technically feasible wireless or wired physical transport technology may be implemented to transmit data between server device 510 and user device 530 without exceeding the scope of the invention, for example using network data packets. Information network 520 may comprise the Internet and/or any other suitable data network system. Firewalls protecting information network 110 at server device 510 and/or user device 530 may or may not be present. The term “application,” as used herein, is defined as a set of one or more processes running on a particular computing device.

Server device 510 may be any computing system that can be configured as a server device to one or more user devices 530 and other client computing devices, such as a server of a cloud computing system. Server device 510 has configured therein a server appraisal application 511 and an appraisal database 512. Server device 510, using server appraisal application 511, is configured to receive a topic appraisal 521, a topic appraisal request 522, and a search request 523 from user device 530, and to send requested topic appraisal 525 and search request response 526 to user device 530.

User device 530 may be any electronic device that can be configured as a client computing device to server device 510 or otherwise communicatively coupled to server device 510, such as a desktop computer, a laptop computer, a smartphone, a digital tablet, a personal digital assistant, a gaming console, or any other technically feasible computing device. User device 530 includes a display device 532 and, in some embodiments, a local application 531 that is configured to facilitate communication between server device 510 and user device 530. Generally, local application 531 includes a graphical counting tool, such as counting tool 100 in FIG. 1.

Topic appraisal 521 generally originates from user device 530 when an end-user evaluates a particular topic using counting tool 100 of FIG. 1 (for example displayed on display device 532). Thus, topic appraisal 521 includes appraisal information for the topic that has been evaluated by the end-user. Specifically, topic appraisal 521 may include descriptive appraisal information associated with the topic evaluated by an end-user and suitable metadata, such as topic name, topic category, user name, and the like. The descriptive appraisal information included in topic appraisal 521 may include one or more language-based descriptors 110 (shown in FIG. 1) that are selected by an end-user when the end-user evaluates the topic. For example, the descriptive appraisal information included in topic appraisal 521 may include a language-based descriptor 110 for the topic overall as well as one or more language-based descriptors 110 for one or more aspects of the topic. In some embodiments, topic appraisal 521 is transmitted to server device 510 through local application 531. For example, local application may be configured to open a shell that directs an end-user to a website implemented by server appraisal application 511. In other embodiments, topic appraisal 521 is transmitted to server device 510 through any suitably configured website, such as an HTML5-capable website. In the latter case, the suitably configured website may be implemented by server appraisal application 511.

Topic appraisal request 522 generally originates at user device 530 when an end-user requests, using counting tool 100, requests a topic appraisal. Counting tool 100 may be implemented by local application 531 or by a suitably configured website implemented by server appraisal application 511. Topic appraisal request 522 may include the topic for which an end-user requests a topic appraisal as well as any metadata that may facilitate the completion of the request by server appraisal application 511. For example, when an end-user is interested in appraisals (e.g., reviews) of a particular movie that have been performed by a predetermined group of end-users (e.g., a group of individuals linked by social media in some way), topic appraisal request 522 may include both the topic and appropriate filtering parameters, such as a list of the specific individuals making up the predetermined group of end-users.

Search request 523 generally originates at user device 530 when an end-user performs a search, using counting tool 100, for existing topic appraisals and/or other information stored in appraisal database 512. Search request 523 may be transmitted to server device 510 via local application 531 or via a suitably configured website implemented by server appraisal application 511. Search request 523 generally includes commands requesting any topic appraisals in appraisal database 512 meeting specified search parameters. Consequently, search request 523 may also include appropriate search parameters for facilitating the implementation of search request 523 by server appraisal application 511. For example, search request 523 may include search parameters such as “all topics that are associated with the descriptor ‘hilarious’,” “all topics that I have selected as ‘hilarious’,” “all topics generated by a particular end-user,” etc. Thus, counting tool 100 can be employed not only for collecting and providing topic appraisals, but can also act as a powerful search instrument for exploring the plurality of topic appraisals stored in appraisal database 512. Because the topic appraisals generated by counting tool 100 and stored in appraisal database 512 include one or more language-based descriptors 110 as well as end-user information, an end-user can, via search request 523, retrieve a topic appraisal based on how the associated topic made him or her feel, or how the topic made any particular group of end-users feel. Furthermore, an end-user (or groups of end-users) may be selected based on what topic appraisals the end-user has generated and/or on specific language-based descriptors 110 the end-user has included in topic appraisals of specific topics. Thus, computer-implemented system 500 can facilitate data-mining based on detailed and high-granularity information regarding end-user interests.

Requested topic appraisal 525 generally originates at server device 510, in response to topic appraisal request 522, and is transmitted to user device 530. Requested topic appraisal 525 may include a topic appraisal retrieved from appraisal database 512 for the specific topic indicated in topic appraisal request 522. In some embodiments, requested topic appraisal 525 may also include any appropriate metadata associated with the requested topic appraisal 525, such as topic category, user name(s), end-users avatars, and the like. Once requested topic appraisal 525 is received by user device 530, descriptive appraisal information and quantitative appraisal information associated with the requested topic are displayed, using counting tool 100, on display device 532.

Search request response 526 generally originates at server device 510, in response to search request 523, and is transmitted to user device 530. Search request response 526 includes one or more topic appraisals satisfying the search parameters included in search request 523. For example, search response 526 may include topic appraisals for: all topics that are associated with a specified language-based descriptor 110; or, only topics that are most frequently associated with a specified language-based descriptor 110; or, all topics that have been appraised by a specified end-user or group of end-users, etc. Once search request response 526 is received by user device 530, descriptive appraisal information and quantitative information associated with any of the topic appraisals included therein may be displayed, using counting tool 100, on display device 532.

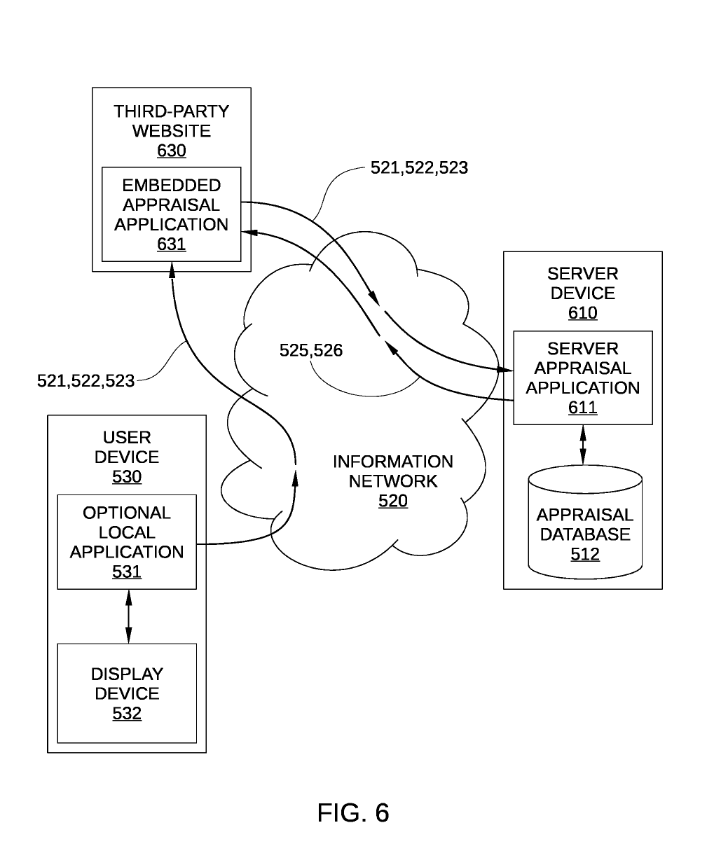

FIG. 6 is a conceptual block diagram illustrating a computer-implemented system 600 configured for collecting and providing information, according to another embodiment of the present invention. Computer-implemented system 600 is substantially similar to computer-implemented system 500 (where server device 610 may include the functionality of server device 510), but also includes a third-party website 630.

Third-party website 630 may be open to any visitors, such as a reviewer website, or may serve a specific population of end-users requiring login, such as a website for a school or other organization. In either case, an end-user may access third-party website 630 via user device 530 to provide a topic appraisal 521. In some embodiments, third-party website 630 receives topic appraisals 521 from end-users with an embedded appraisal application 631, which is configured to provide some or all of the topic appraisal functionality described above in conjunction with server appraisal application 511 of FIG. 5. In other embodiments, third-party website 630 may employ topic appraisal functionality provided by server device 610 as a multi-tenant application. In such embodiments, data aggregation and/or data mining of a plurality of third-party websites 630 is facilitated in server device 611. Furthermore, in such embodiments, topic appraisals 521 may be uploaded to server device 611 from third-party website 630 as shown. Requested topic appraisals 525 and search request responses 526 may be returned to third-party website 630 in response to topic appraisal requests 522 and search requests 523, as described above in conjunction computer-implemented system 500 in FIG. 5. Alternatively, when third-party websites 630 includes embedded appraisal application 631, third-party website 630 may provide requested topic appraisals 525 and search request responses 526 directly in response to topic appraisal requests 522 and search requests 523 from user device 530.

In the embodiment illustrated in FIG. 6, third-party website 630 is configured to access a remote database, such as appraisal database 512 of server device 610. In other embodiments, third-party website 630 may be configured with or is directly associated with a database distinct from appraisal database 512.

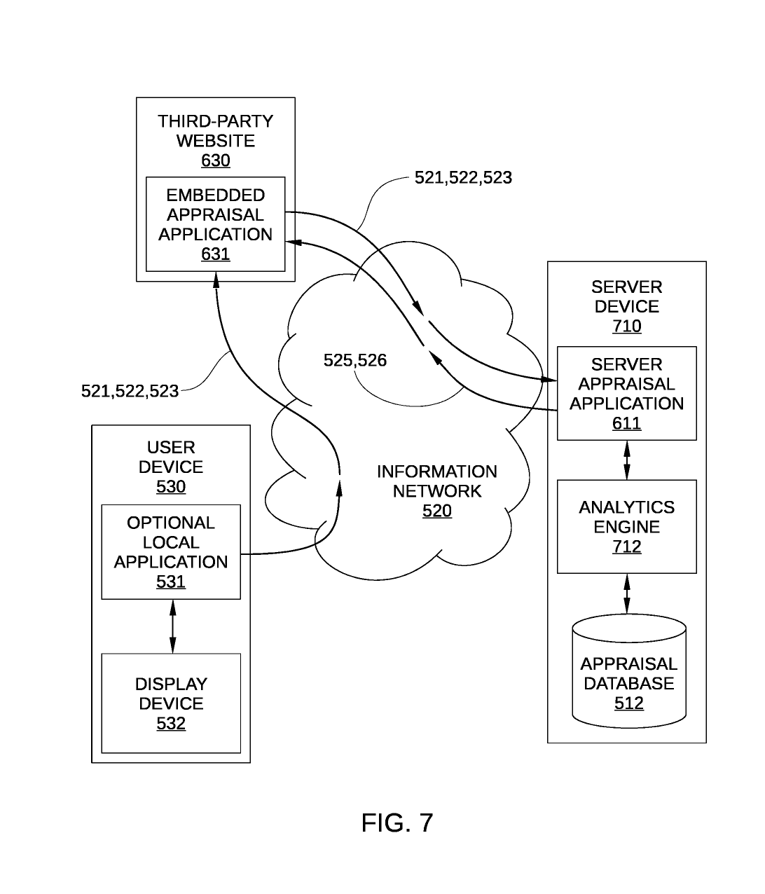

FIG. 7 is a conceptual block diagram illustrating a computer-implemented system 700 configured for collecting and providing information, according to another embodiment of the present invention. Computer-implemented system 700 is substantially similar to computer-implemented system 600 (where server device 710 may include the functionality of server device 610), except that server device 710 may have configured therein an analytics engine 712.

Analytics engine 712 is configured to compare the reactions of end-users to various topics and determine compatibilities and/or incompatibilities between specific end-users in various contexts. For example, analytics engine 712 may be configured to determine compatibility between end-users in the context of dating, employment searches, roommate selection, and placement within an organization, among others. Such analysis is made possible by information stored in appraisal database 512, specifically the high-granularity, context-rich information associated with end-user reactions to or feelings about a plurality of topics. Furthermore, in some embodiments, counting tool 100 may be used to collect information specifically for such analysis.

In some embodiments, counting tool 100 may be employed to collect and display appraisal information associated with a topic with respect to time. For example, topic appraisals 521 may include time-specific metadata, allowing a complete history of the topic appraisals 521 for a specific topic to be viewed. Such temporal analysis can be very informative for marketing and other applications. For example, a history of topic appraisals 521 for a television program can be viewed over a finite period of time (e.g., over one episode or over an entire season) to analyze viewer response and search for spikes in positive and/or negative reactions.

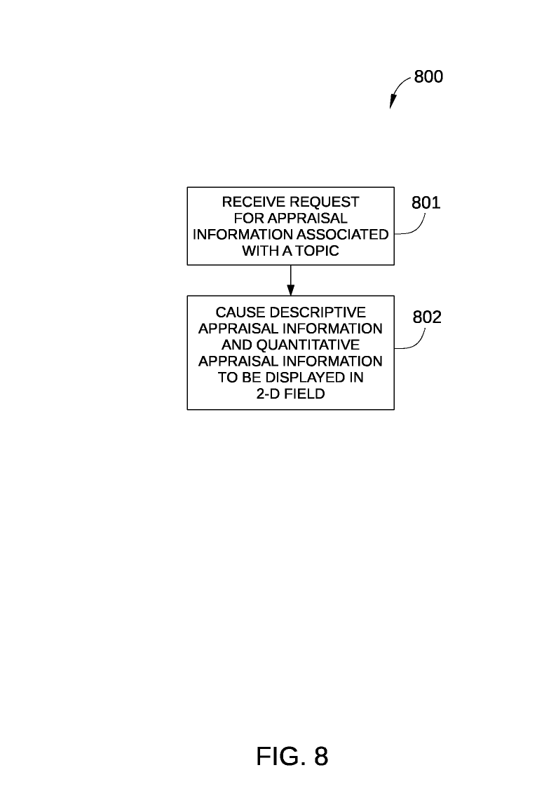

FIG. 8 sets forth a flowchart of computer-implemented method steps for providing information, according to one embodiment of the present invention. Although the method steps are described in conjunction with computer-implemented system 500 in FIG. 5 and computer-implemented system 600 in FIG. 6, persons skilled in the art will understand that the method in FIG. 8 may also be performed with any other suitable computer-implemented system. Prior to the method steps, a server device generally receives and stores a plurality of user-generated topic appraisals that each include descriptive appraisal information associated with a topic and quantitative information associated with the topic.

As shown, a method 800 begins at step 801, where a server device, such as server device 510 or server device 610, receives a request for appraisal information associated with a topic, such as a topic appraisal, via information network 520. Typically, such a request is initiated by an end-user that is interested in a specific topic, and employs counting tool 100 to generate the request.

In step 802, the server device causes descriptive appraisal information associated with the topic and quantitative appraisal information associated with the topic to be graphically displayed in conjunction with two-dimensional field 103. For example, the server device may transmit a topic appraisal (or multiple topic appraisals) to a user device from which the request originated for display on the user device. Specifically, displaying the topic appraisal may include causing a value icon 201 to be displayed at a location in two-dimensional field 103. In some embodiments, the value icon 201 has a characteristic, a value of the characteristic being related to a value of the quantitative appraisal information.

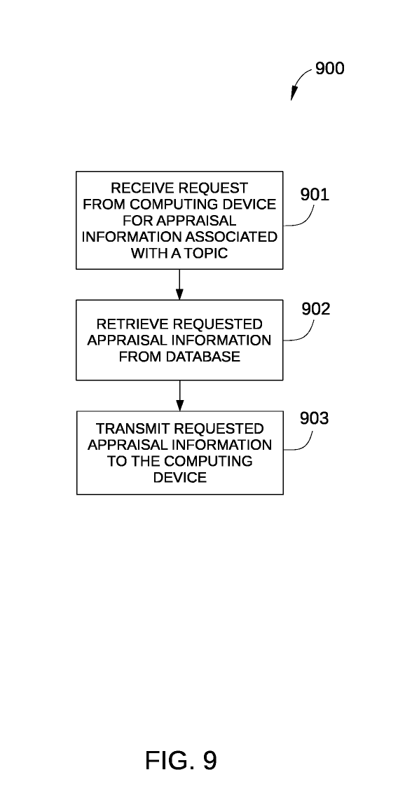

FIG. 9 sets forth a flowchart of computer-implemented method steps for searching for appraisal information associated with a topic, according to one embodiment of the present invention. Although the method steps are described in conjunction with computer-implemented system 500 in FIG. 5 and computer-implemented system 600 in FIG. 6, persons skilled in the art will understand that the method in FIG. 9 may also be performed with any other suitable computer-implemented system. Prior to the method steps, a server device generally receives and stores in appraisal database 512 a plurality of user-generated topic appraisals that each include descriptive appraisal information associated with a topic and quantitative information associated with the topic.

As shown, a method 900 begins at step 901, where a server device, such as server device 510 or server device 610, receives a request from a computing device, such as user device 530, via information network 520 for appraisal information associated with a particular topic, such as a topic appraisal. The request includes at least one of selected descriptive appraisal information associated with the topic (e.g., one or more language-based descriptors 110) and selected quantitative appraisal information associated with the topic (e.g., the number of end-users associated with each language-based descriptor 110). In some embodiments, counting tool 100 is used to generate the request.

Typically, such a request is initiated by an end-user that is searching for one or more topic appraisals that meet search criteria defined by the selected descriptive appraisal information included in the request, the selected quantitative appraisal information included in the request, or a combination of both. Thus, the selected descriptive appraisal information and/or the selected quantitative appraisal information may be used as search criteria. However, in some embodiments, the search request may be initiated by a different entity, such as a commercial entity performing data mining or data aggregation based on the selected descriptive appraisal information associated with one or more topics and stored in appraisal database 512.

In step 902, based on at least one of the selected descriptive appraisal information and selected the quantitative appraisal information included in the request received in step 901, the server device retrieves one or more topic appraisals. Specifically, the topic appraisals that satisfy the search criteria in the request are retrieved from appraisal database 512.

In step 903, the server device transmits the requested appraisal information (e.g., the one or more appraisal topics retrieved in step 902) to the computing device that originated the request in step 901.

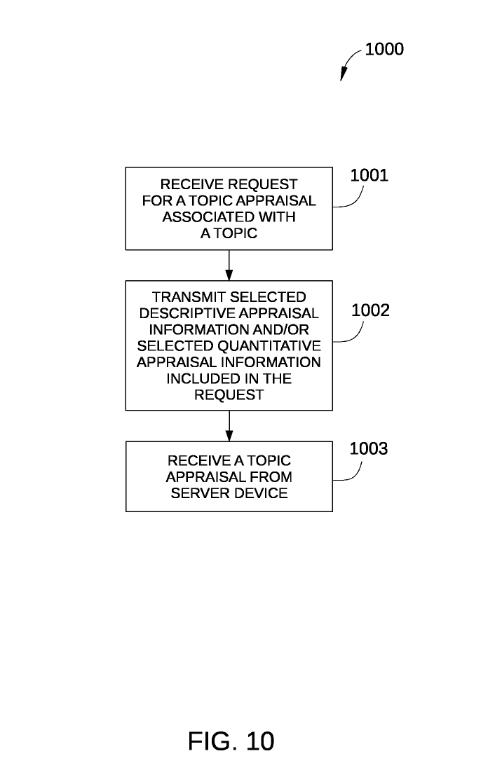

FIG. 10 sets forth a flowchart of computer-implemented method steps for retrieving information from a database, according to one embodiment of the present invention. Although the method steps are described in conjunction with computer-implemented system 500 in FIG. 5 and computer-implemented system 600 in FIG. 6, persons skilled in the art will understand that the method in FIG. 10 may also be performed with any other suitable computer-implemented system. Prior to the method steps, a server device generally receives and stores in appraisal database 512 a plurality of user-generated topic appraisals that each include descriptive appraisal information associated with a topic and quantitative information associated with the topic.

As shown, a method 1000 begins at step 1001, where local application on a user device, such as user device 530, receives a request for appraisal information associated with a topic (e.g., a topic appraisal). The request includes at least one of selected descriptive appraisal information associated with the topic and selected quantitative appraisal information associated with the topic. For example, the local application may receive such a request when an end-user employs counting tool 100 to search for any or all topic appraisals stored in appraisal database 512 that meet certain search criteria included in the request. Specifically, the search criteria may include the selected descriptive appraisal information included in the request, the selected quantitative appraisal information included in the request, or a combination of both. Thus, an end-user may initiate the request received in step 1001 by selecting one or more language-based descriptors 110 displayed in two-dimensional field 103 of counting tool 100.

In step 1002, the local application loaded on the user device transmits via information network 520 the selected descriptive appraisal information and/or the selected quantitative appraisal information included in the request (e.g., the search criteria for the search) to server device 510.

In step 1003, the local application loaded on the user device receives the requested appraisal information from server device 510 via information network 520.

In sum, embodiments of the present invention set forth systems and methods for collecting and providing appraisal information associated with one or more topics by employing a graphically displayed interface. The interface is configured to graphically display descriptive appraisal information (language-based descriptors) and quantitative appraisal information (number-based descriptors) associated with a topic in a two-dimensional field as a semi-ordered perceptual map of choices. Such a choice map represents qualitative assessments of a particular topic in a way that facilitates immediate understanding of the feedback from a large number of end-users.

One advantage of the above-described embodiments is the ability to collect qualitative assessments of a topic with the efficiency and simplicity of a conventional numerical rating system. Another advantage is that such qualitative assessments, once collected, can be readily accessed and searched, and the results of such a search can be quickly interpreted. A further advantage is that data aggregation in terms of specific language-based descriptors provides an additional layer of subjective, but easily understood feedback.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

While the foregoing is directed to embodiments of the present invention, other and further embodiments of the invention may be devised without departing from the basic scope thereof, and the scope thereof is determined by the claims that follow.

We claim:

1. A computer-implemented method of providing information, the method comprising:
receiving a request for appraisal information associated with a topic via an information network; and
causing descriptive appraisal information associated with the topic and quantitative appraisal information associated with the topic to be graphically displayed in conjunction with a two-dimensional field that includes a first axis and a second axis,
wherein the first axis represents an appraisal scale of the topic with respect to a first metric and the second axis represents an appraisal scale of the topic with respect to a second metric.

2. The method of claim 1, wherein the first metric comprises an intellectual intensity attributed to the topic and the second metric comprises an emotional intensity attributed to the topic.

3. The method of claim 2, wherein the first metric comprises an intellectual intensity attributed to the topic by an end-user that generates the request for appraisal information and the second metric comprises an emotional intensity attributed to the topic by the end-user.

4. The method of claim 2, wherein the first metric comprises an intellectual intensity attributed to the topic by multiple end-users and the second metric comprises an emotional intensity attributed to the topic by the multiple end-users.

5. The method of claim 1, wherein causing quantitative appraisal information associated with the topic to be graphically displayed comprises causing an icon having a characteristic to be displayed at a location in the two-dimensional field, a value of the characteristic being related to a value of the quantitative appraisal information.

6. The method of claim 5, wherein the characteristic of the icon comprises at least one of height, width, area, and color.

7. The method of claim 5, wherein the value of the characteristic varies as the value of the quantitative appraisal information varies.

8. The method of claim 5, wherein the characteristic of the icon comprises at least one of height, width, and area, and the value of the characteristic increases as the value of the quantitative appraisal information increases.

9. The method of claim 5, wherein the icon is configured to indicate a specific end-user associated with descriptive appraisal information associated with the topic that corresponds to the location.

10. The method of claim 1, wherein the quantitative appraisal information comprises a number of end-users that have provided appraisal information associated with the topic.

11. The method of claim 1, wherein the quantitative appraisal information comprises a number of users that have associated a specific instance of descriptive appraisal information with the topic.

12. The method of claim 1, wherein the two-dimensional field includes a plurality of locations, each of the locations corresponding to a unique language-based descriptor.

13. The method of claim 12, wherein the two-dimensional field is associated with a single attribute of the topic.

14. The method of claim 13, wherein the unique language-based descriptor at each location is selected based on the single attribute.

15. The method of claim 12, wherein the descriptive appraisal information corresponds to at least one of the unique language-based descriptors.

16. The method of claim 12, wherein one or more of the unique language-based descriptors is associated with a subset of additional language-based descriptors, the subset comprising a second level of descriptive appraisal information related to the topic.

17. The method of claim 16, wherein at least one language-based descriptor in the subset comprises a descriptor that originates from an end-user input related to the topic.

18. The method of claim 12, wherein at least one of the unique language-based descriptors is selected based on a category of the topic.

19. The method of claim 12, wherein at least one of the unique language-based descriptors is selected based on an end-user associated with the descriptive appraisal information.

20. The method of claim 12, wherein at least one of the unique language-based descriptors is selected based on a demographic or psychographic profile associated with the end-user.

21. The method of claim 1, further comprising, prior to causing the descriptive appraisal information and the quantitative appraisal information to be graphically displayed, receiving the descriptive appraisal information and the quantitative appraisal information from multiple end-users.

22. The method of claim 1, wherein the first axis and the second axis are positioned in the two-dimensional field to form four quadrants in the two-dimensional field.

23. The method of claim 22, wherein a neutral point of the first axis is substantially collocated with a neutral point of the second axis.

24. The method of claim 1, wherein causing the descriptive appraisal information and the quantitative appraisal information to be graphically displayed comprises transmitting the descriptive appraisal information and the quantitative appraisal information via an information network to a computing device for display.

25. A computer-implemented method of searching for appraisal information associated with a topic, the method comprising:
receiving a request from a computing device via an information network for appraisal information associated with a topic, the request including at least one of selected descriptive appraisal information associated with the topic and selected quantitative appraisal information associated with the topic;
based on at least one of the selected descriptive appraisal information and the selected quantitative appraisal information, retrieving the requested appraisal information from a database; and
transmitting the requested appraisal information to the computing device via the information network,
wherein the selected descriptive appraisal information and the selected quantitative appraisal information are selected from a two-dimensional field that is graphically displayed by the computing device and includes a first axis and a second axis, and
wherein the first axis represents an appraisal scale of the topic with respect to a first metric and the second axis represents an appraisal scale of the topic with respect to a second metric.

26. The method of claim 25, wherein transmitting the appraisal information comprises transmitting descriptive appraisal information associated with the topic and quantitative appraisal information associated with the topic.

27. The method of claim 25, wherein the requested appraisal information comprises end-user information for a first end-user that has generated descriptive appraisal information associated with the topic.

28. The method of claim 27, further comprising determining a compatibility between the first end-user and a second end-user based on the descriptive appraisal information generated by the first user.

29. A computer-implemented method of retrieving information from a database, the method comprising:
receiving a request for appraisal information associated with a topic, the request including at least one of selected descriptive appraisal information associated with the topic and selected quantitative appraisal information associated with the topic, wherein the selected descriptive appraisal information and the selected quantitative appraisal information are selected from a two-dimensional field that is graphically displayed by a first computing device and includes a first axis and a second axis, the first axis representing an appraisal scale of the topic with respect to a first metric and the second axis representing an appraisal scale of the topic with respect to a second metric;
transmitting via an information network at least one of the selected descriptive appraisal information and the selected quantitative appraisal information to a second computing device that is associated with the database; and
receiving the requested appraisal information from the second computing device via the information network.

30. The method of claim 29, further comprising, upon receiving the requested appraisal information, causing the requested appraisal information to be graphically displayed in conjunction with the two-dimensional field that includes a first axis and a second axis.
